(19) United States
(12) Patent Application Publication
(10) Pub. No.: US 2003/0079048 A1
(43) Pub. Date: Apr. 24, 2003

(54) Basic architecture for software environment of radio terminal and method of handling events in the same

(75) Inventor: Hyung Jung Kim, Koyang-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/158,913

(22) Filed: Jun. 3, 2002

(30) Foreign Application Priority Data
Jun. 4, 2001 (KR) P2001-31163

(51) Int. Cl. G06F 9/00; G06F 9/46

(52) U.S. Cl. 709/318; 709/328

(57) ABSTRACT

A Basic Architecture for Software Environment(BASE) of a radio terminal and a method of handling events in the same are disclosed. The BASE and the method can simply make an application programs by module and apply the independence to the application programs by changing a structure of some parts corresponding to User Interface (UI) or Man Machine Interface (MMI) among software codes used in the radio terminal.

Pursuant to 35 U.S.C. § 119(a), this application claims the benefit of earlier filing date and right of priority to the Korean Application No.P2001-31163 filed on Jun. 04, 2001, the content of which is hereby incorporated by reference herein in its entirety.

### BACKGROUND OF THE INVENTION

1. Field of The Invention

The present invention relates to a radio communication service and more particularly to a Basic Architecture for Software Environment(BASE) of a radio terminal and a method of handling events in the same.

2. Discussion of the Related Art

Generally, A radio communication has been mainly applied to a restricted field for a specific purpose until the end of 1970's. The market of a radio communication has extremely expanded after commercially providing subscribers with the radio communication service using technique of the radio communication early in 1980's.

In the first of 1990's, digitalization of communication technique has affected the radio communication and resulted in the age of the digital mobile communication. Thereby, the market of the communication service has undergone a change from the age of a cellular radio communications service using a macro cell to the age of a Personal Communications Service (PCS) using a micro cell.

A mobile communication service with an analog method has been provided in Korea since 1984. The technique for the mobile communication has been rapidly developed. A research for a mobile communication service with a digital method has begun from the end of 1980's. A Code Division Multiple Access(CDMA) method, a software solution of Qualcomm, has been adopted as the standard of a domestic digital mobile communication service. Thereafter, a CDMA system has been developed in 1995 and a digital cellular mobile communication service with a CDMA method has commercially used.

FIG. 1 illustrates a Basic Architecture for Software Environment(BASE) of a radio terminal in accordance with the related art, and FIG. 2 illustrates a configuration of a User Interface(UI) in accordance with the related art.

As shown in FIG. 1, the BASE of a radio terminal includes a task part 10 having a HandSet(HS) task, a Main Control(MC) task, a Call Manager(CM) task, and a File System(FS) task and a BASE UI 20 performing corresponding applications by using events generated by the task part 10 wherein the BASE UI 20 has a structure of a state machine.

The BASE UI 20 includes an event handler 21 handling events and signals generated by the task part 10, an application part 22 processing the events and signals output from the event handler 21, and an application manager part(not shown) terminating, operating, and managing the application part 22.

Software relevant to the aforementioned BASE UI 20 has a structure of a state machine. Since the structure makes dependent states, all of the states must add new information relevant to adding a new function. That is, in FIG. 2, if a radio terminal turns on, it first calls ui_init, the first signal of the UI task within the task part 10 and then rex_wait ( ) maintaining a stand-by state.

If signals and events such as ui_signal, priority event, info msg from BS, key etc. are input to the event handler 21 within the BASE UI 20, the event handler 21 calls a function corresponding to the input signals and events. Mainly, ui_do_event ( ) having a structure of the state machine processes the input signals and events. Since the ui_do_event ( ) has the structure of a state machine, it must cooperate with plural states for implementing a new application and newly code the corresponding states.

That is, it is indispensable to change a predetermined code for the new application. Also, the structure makes a reuse of the predetermined code impossible. Since one state is not independently coded with other states, a developer must be provided with total source codes when an application with the states is developed by external service, which may flow out the source codes unintentionally.

A continuous upgrade of a system makes a probability of its unintentional error much higher because one state cooperates with other states, makes independence of application programs and a reuse thereof impossible.

### SUMMARY OF THE INVENTION

Accordingly, the present invention is directed to a BASE of a radio terminal and a method of handling events in the same that substantially obviates one or more problems due to limitations and disadvantages of the related art.

An object of the present invention is to provide a BASE of a radio terminal and a method of handling events in the same that obtains independence of application programs by implementing an application program handler managing the application programs.

Another object of the present invention is to provide a basic architecture of a framework for software environment in a radio terminal and a method of the same, each application program is so independently compiled and linked that it may have a module format.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a Basic Architecture for Software Environment (BASE) of a radio terminal includes a task part having a plurality of tasks and generating working events, a BASE user interface (UI) independently performing an application program by module by using the events generated by the task part, and an application program interface (API) interfacing the application program with a program development kit (PDK) library so that the application program may access the PDK library.

Preferably, the BASE UI includes a PDK handler handling events generated within the PDK and signals and the events generated by the task part, a preprocessor processing and determining events to be first processed among the events output from the PDK handler, a SPY handler processing and determining events to be processed in common for all of the application programs among the events not processed by the preprocessor, a state machine processing the events output from and not processed by the SPY handler, wherein the events are not independently processed, an application part independently processing the events output from and not processed by the SPY handler, an application handler providing and identifying the corresponding event for each application of the application part, and an application manager part managing, activating, and terminating the application part.

Preferably, the tasks are HandSet(HS,) task, Main Control(MC) task, Call Manager(CM) task, and File System(FS) task.

Preferably, the SPY handler includes a system spy checking whether events processed in common exist or not, and an application SPY processing corresponding events after operation of the system spy.

In another aspect of the present invention, a method of handling events in a BASE of a radio terminal, the BASE including an application handler, a plurality of applications, and a PDK of development environment, the method includes (a) transforming all of the events except for events used by a PDK under the status of development provided by the BASE among the generated events into available events and storing the transformed events in a queue, (b) orderly reading first stored events from the queue and preprocessing predetermined events, (c) processing events required in common by all of the application programs among the events not processed in the step (b), (d) processing events such as startup, end, call, and idle among the events not processed in the step (c) and searching an activated application, (e) transferring the events not processed in the step (d) to the searched application, (f) processing the events not processed using an independent program module of the activated application.

Preferably, the events transformed in the step (a) include key down, timer check, Short Message Service(SMS), serial, and pointing.

Preferably, the step (f) includes (a1) selecting one of a plurality of applications and initiating variables, (b1) informing an application handler of the selected application, (c1) generating a terminating event for terminating an activated application at the application handler and providing the activated application with it, (d1) performing the terminating procedure after processing all of the remaining events stored in the queue when the activated application receives the terminating event, (e1) generating an activating event for the selected application at the application handler and transferring it to the selected application, (f1) transferring the selected application's information to the application handler and storing the transferred information at the application handler, and (g1) performing an initiating procedure and processing input events at the selected application.

Preferably, the information stored by the application handler includes file header information, registery information, location information of a program code, location information of small icon data, location information of large icon data, location information of resource data, a code table of program offset, icon data of a program code, and resource data.

Preferably, the terminating procedure of a current application activated from the selected application includes (a2) transferring a terminating signal for terminating the current application into the application handler, (b2) generating a terminating event informing that the current application terminates when the application handler receives the terminating signal and generating an activating event informing that a previously terminated application is again activated, (c2) processing all of the events remaining in the queue at the current application and transferring the generated terminating event to a current application through the application handler to perform the termination procedure, (d2) transferring the generated activating event to the previously terminated.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a BASE of a radio terminal using a system with a software solution in accordance with the related art.

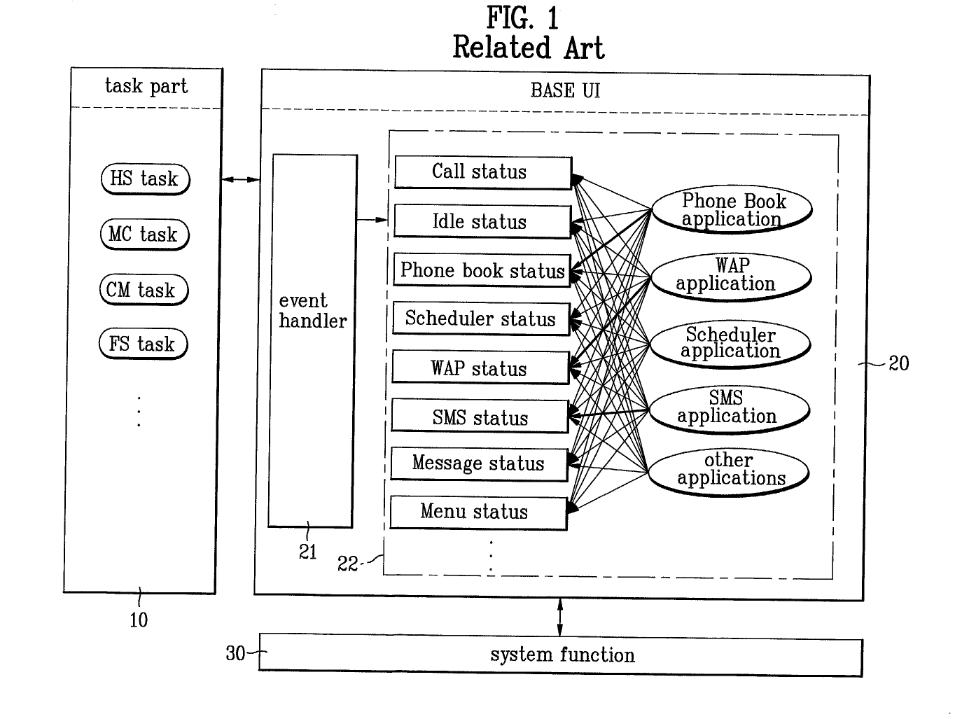

FIG. 2 illustrates a configuration of a BASE UI in accordance with the related art.

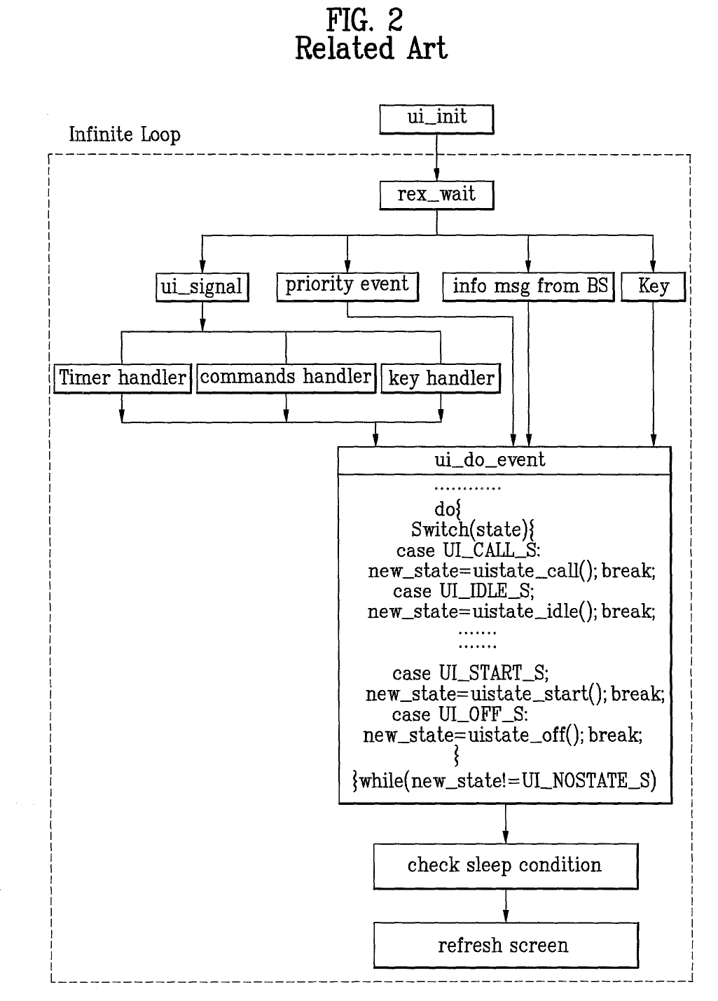

FIG. 3 illustrates a BASE of a radio terminal in accordance with the preferred embodiment of the present invention.

FIG. 4 illustrates a configuration of a BASE UI in accordance with the preferred embodiment of the present invention.

FIG. 5 illustrates a flow chart of the process of events in a BASE of a radio terminal in accordance with the preferred embodiment of the present invention.

FIG. 6 illustrates a flow chart of the process that an application manager part activates a new application in accordance with the preferred embodiment of the present invention.

FIG. 7 illustrates a flow chart of the process that the application manager part terminates an activated application in accordance with the preferred embodiment of the present invention.

### DETAILED DESCRIPTION OF THE INVENTION

Reference will now be made in detail to the preferred embodiments of the present invention, examples of which are illustrated in the accompanying drawings Wherever possible, the same reference numbers will be used throughout the drawings to refer to the same or like parts.

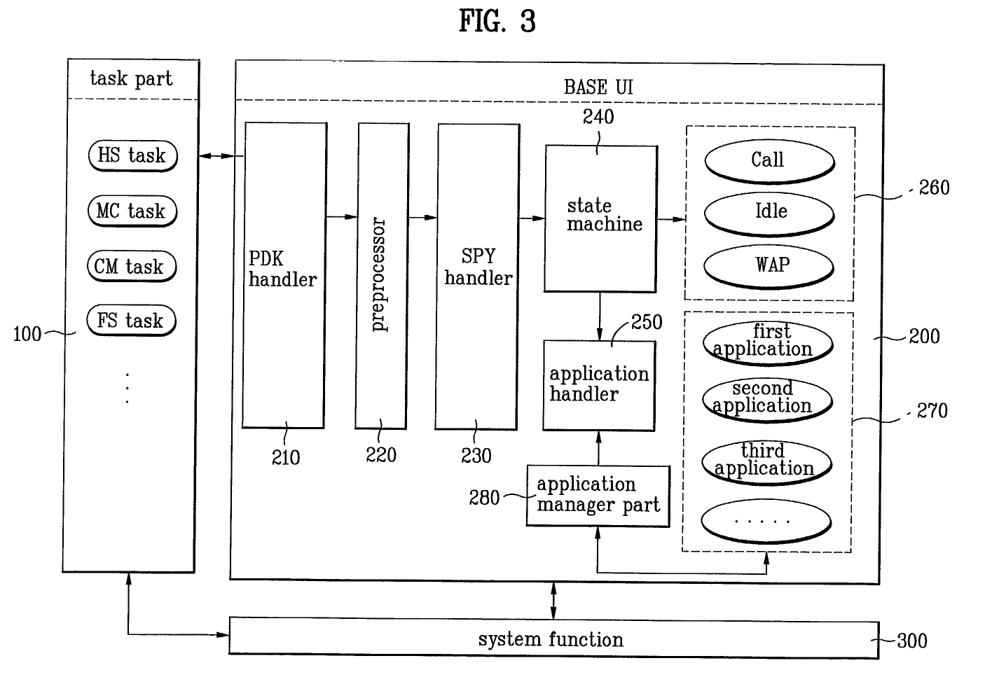

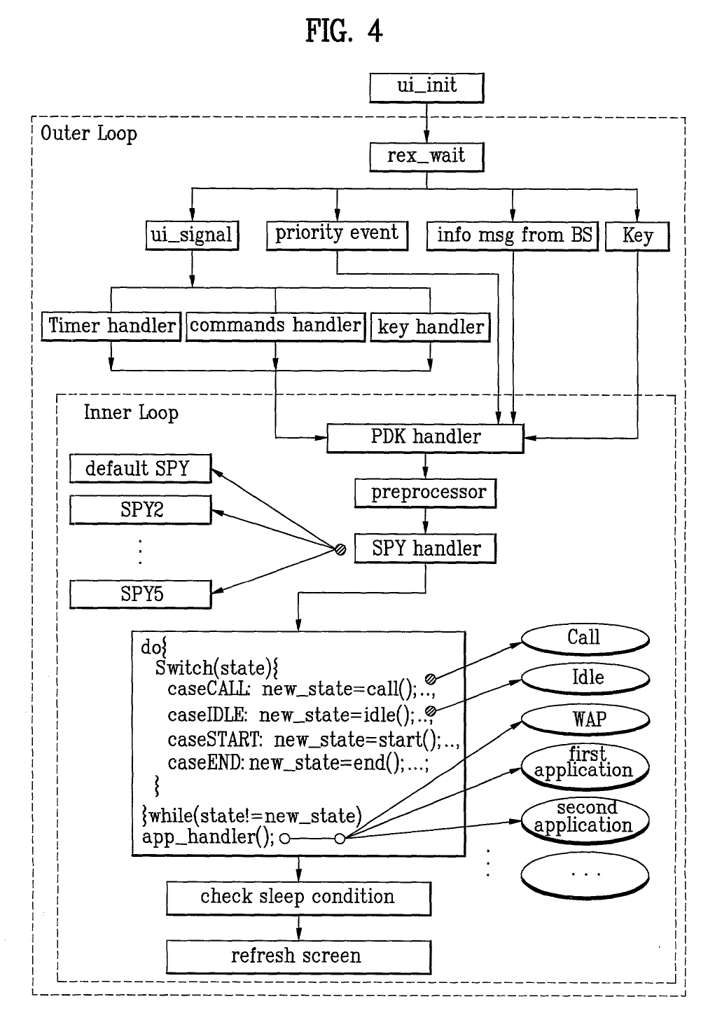

FIG. 3 illustrates a BASE of a radio terminal in accordance with the preferred embodiment of the present invention. FIG. 4 illustrates a configuration of a BASE UI in accordance with the preferred embodiment of the present invention.

In FIG. 3, a BASE of the present invention includes a task part 10 having a HandSet(HS) task, a Main Control(MC) task, a Call Manager(CM) task, and a File System(FS) task etc. and generating signals and events, BASE UI 20 respectively performing an application program by module using events generated by the task part 100, and an Application Program Interface(API) 300 that the application can interface with a program development kit(PDK) library.

The BASE UI 200 includes a PDK handler 210 handling events generated within PDK and the signals and events generated by the task part 100, a preprocessor 220 determining events to be first processed among the events output from the PDK handler 210 and processing the determined events before transferring the generated events to each state machine 240, a SPY handler 230 processing and checking events to be processed in common for all of the application programs among the events not processed by the preprocessor 220, a state machine 240 processing events not to be independently processed among the events output from the SPY handler 230, an application handler 250 transferring events output from the state machine 240 to one independent application of an application part 270, the application part 270 independently processing the events transferred from the application handler 250, and an application manager part 280 terminating, operating, and managing the application part 270.

The task part 100 is used as the foregoing method when the Qualcomm's code is newly released. That is, its code is continuously ported when the specification is upgraded or a new function is added.

The PDK handler 210 includes at least queue and processes events used both in a conventional Qualcomm's code and in PDK under the status of development provided by the BASE UI 200. The structure of the used events is as follows.

Typedef struct
{
WORD OrEvent ;//a value of an event generated by

UT_TASK

WORD Type;
DWORD wParam;
DWORD 1Param;
}stPDKEvent;

The OrEvent with WORD type is a variable for an event used in a conventional Qualcomm's code. If the value of the OrEvent is not zero, the value of the wParam and 1Param with the DWORD type is zero. The Type with WORD type is a variable for an event generated within the PDK. The wParam and 1Param with DWORD type have a different value in accordance with a plurality of events.

The preprocessor 220 is embodied on the front end of the state machine 240 and called per at least 250 msec. The preprocessor 220 corresponds to codes processed irrelevant to the state machine 240 and is used to mainly display a status, or animation, etc.

As shown in FIG. 4, the configuration of the BASE UI 200 provides a relation of its elements and a flow chart processing events. The BASE UI 200 is divided into an inner loop and an outer loop.

The basic architecture of the mobile terminal in accordance with the preferred embodiment of the present invention will be concretely explained referring the drawings below.

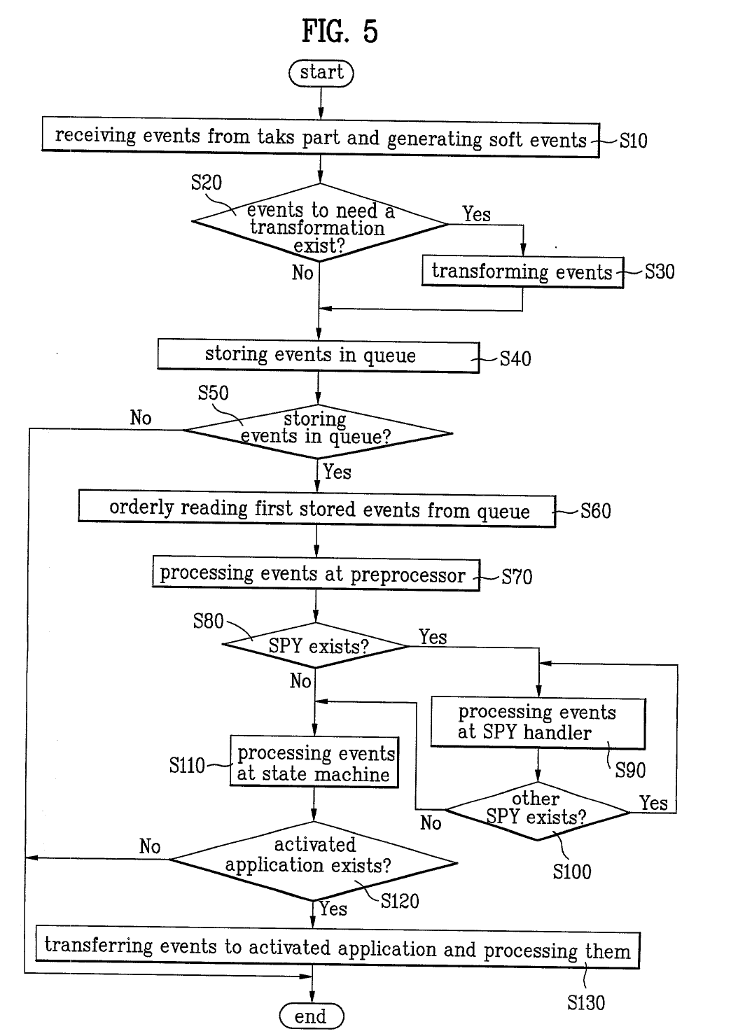

FIG. 5 illustrates a flow chart processing events in a basic architecture of a radio terminal in accordance with the preferred embodiment of the present invention.

Referring to FIG. 5, if the first and second events are respectively generated by the task part 100 and the program development kit (PDK) under the status of development provided by the BASE UI 200 (S10). The queue included by the PDK handler 210 stores the generated events (S40).

Some of the first events such as key down, timer check, Short Message Service (SMS), packet, serial, and pointing etc., should be transformed to the second events (or PDK events) used in PDK. Therefore, if the events to be transformed exist (S20), the PDK handler 210 transforms them into the PDK events and then stores the transformed PDK events in the queue.(S40)

Thereafter, the preprocessor 220 checks whether the events stored in the queue exist or not (S40), and if so, processes(S70) and orderly reads(S60) first stored events from the queue. At this time, it processes and defines events to be first processed before being processed in each state when the events are generated.

The SPY handler 230 checks whether an event having a SPY exists or not among the events output from the preprocessor 220 (S80), and if so, processes it (S90).

The SPY is a program module for processing and previously checking events generated in a radio terminal before they are transferred to an application program. That is, the present invention first processes the events processed in common by using the spy for all of the application programs.

The SPY has two kinds of a system spy and an application spy. The system spy is operated between the PDK handler 210 and the preprocessor 220 and checks events throughout the system. The application spy processes events added thereafter.

The spy handler 230 should not process events required in common by all of the application programs because it first processes and analyzes events before all of the application programs do them.

If the SPY handler 230 processes all of the spy (S100) or it is checked that the any event output from the PDK handler 210 doesn't have the spy (S80), the spy handler 230 outputs the events to the state machine 240.

The state machine 240 processes the events which are transferred and transfromed into available events by the SPY handler 230. The state machine 240 has plural independent codes divided from Qualcomm's codes of the conventional state machine as described in table 1, thereby, the state machine 240 is simply implemented.

TABLE 1

| State of Conventional | |
|---|---|
| Qualcomm's code | Independent application |
| UI_CODE_S | LOCK API |
| UI_MESSAGE_S | DISPLAY API |
| UI_INFO_S | DISPLAY API |
| UI_LIST_S | PDK API |
| UI_NUMEDIT_S | PDK API (IDLE, CALL) |
| UI_RCL_S | CALL HISTORY APP |
| UI_STO_S | PIM APP |
| UI_MENU_S | SETTING APP |
| UI_SMS_S | (FOREGROUND) SMS APP |
| | (BACKGROUND) SPY |
| UI_ALPHAEDIT_S | EDIT API |
| UI_SERVICE_S | SETTING APP |
| UI_CLI_S | CLI API |
| UI_HELP_S | PDK API |

Table 1The state machine 240 further has states such as Startup, End, Call, Idle etc., wherein the states are the same as those of the conventional Qualcomm's codes.

The present invention maintains independence of each application because most commands or events generated in a radio terminal and transferred to the UI are independently processed by identifying the codes as shown in table 1.

That is, the state machine 240 itself processes some events defined as Startup, End, Call, Idle state among its input events and transfers other events except for them to the application handler 250 (S110).

Then, the application handler 250 searches whether an activated application in the application part 270 exists or not (S120). Also, it transfers a generated event to the activated application. Then, the activated application performs the transferred events by the independent program module. At this time, the application manager part 280 manages a plurality of applications loaded on a radio terminal, for example, terminates and activates the application part 270.

An operation of the application manager part 280 manages is concretely described referring to the drawings below.

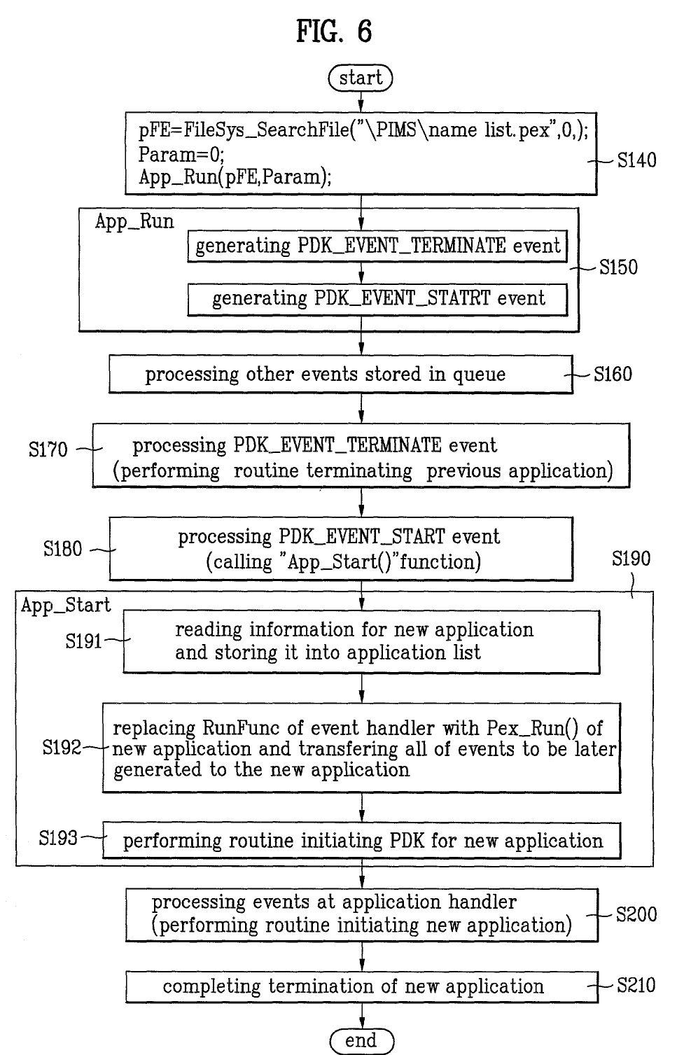

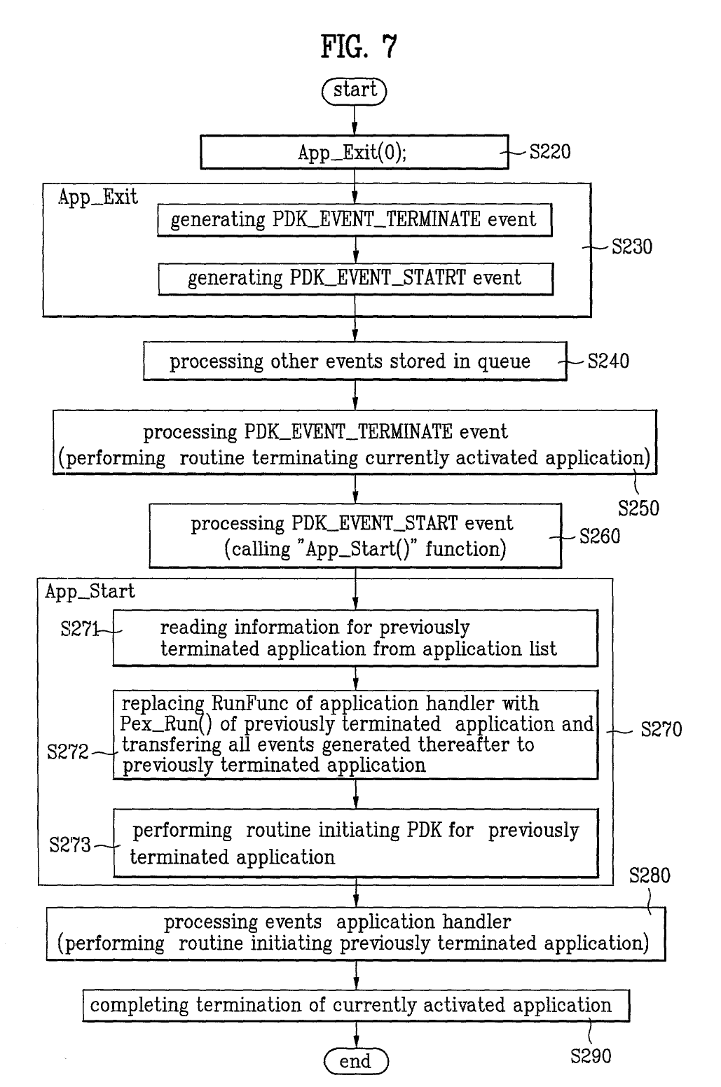

FIG. 6 illustrates a flow chart of a procedure that the application manager part activates a new application in accordance with a preferred embodiment of the present invention, FIG. 7 illustrates a flow chart of a procedure that the application manager part terminates the activated application in accordance with the preferred embodiment of the present invention.

First, in FIG. 6, the application manager part 280 selects one of a plurality of applications (pFE=FileSys_SearchFile) of the application part 270 and initiates a variable (Param=0) The application manager part 280 provides the application handler 250 with App_Run signal in order to activate a new application (S140).

Then, the application manager part 280 generates PDK_EVENT_TERMINATE events indicating that the activated application is terminated, and PDK_EVENT_START events indicating that a new application is activated (S150).

Then, the application manager part 280 processes all of the remaining events stored in the queue (S160) and transfers the generated PDK_EVENT_TERMINATE events to the previously activated application through the application handler 250.

Therefore, the previously activated application processes a termination required by itself (S170).

Then, the applications manager part 280 transfers the generated PDK_EVENT_START event to the newly selected application through the application handler 250 (S180).

Then, the newly selected application transfers its information to the application handler 250. The application handler 250 stores the newly selected application's information into an application list (S191). Also, it replaces its function such as “runFunc” with a PXP file of the newly selected application, thereby resulting in that all of the events generated thereafter can be provided to the newly selected application (S192).

The PXP file includes contents such as file header information, registry information, location information of a program code, location information of small icon data, location information of large icon data, location information of resource data, a code table of program offset, icon data of a program code, and resource data, etc.

Then, the application handler 250 performs a routine initiating PDK for the newly selected application. The newly selected application processes the events input from the state machine 240(S200).

An operation of the newly selected application is completed by using the process.

The process terminating a currently activated application will be described referring to FIG. 7.

First, the application manager part 280 transfers an App_Exit signal to the application handler 250 in order to terminate a currently activated application of the application part 270 (S220).

Then, the application manager part 280 generates PDK_EVENT_TERMINATE events in order to terminate the currently activated application and PDK_EVENT_START events in order to again activate the previously terminated application of the application part 270 (S230). As described above, information of the previously terminated application is stored in the application list.

After the application manager part 280 processes the remaining events stored in the queue (S240), it transfers the generated PDK_EVENT_TERMINATE event to the currently activated application through the application handler 250. Then, the currently activated application processes a termination required by itself (S250).

Then, the application manager part 280 transfers the previously terminated application to the generated PDK_EVENT_START event through the application handler 250 (S260).

Then, the application handler 250 reads the information of the previously terminated application from the application list (S271). Also, it replaces its ‘run’ function (runFunc) with a PXP file of the previously terminated application, thereby resulting in that the present invention can provide the application again activated from previously terminated application with all of the events.

Then, the application handler 250 performs a routine initiating PDK of the previously terminated application for again activating it (S273) and processes events input from the state machine 240 (S280).

The current application is terminated through the above steps (S290).

The BASE and the method of handling events in the same according to the present invention have the following advantages.

First, even if a programmer who doesn't know Code Division Multiple Access method, he/she can perform a coding on a personal computer.

Second, the parallel development of software and hardware by module is possible.

Third, a coding and debugging can be made through a simulation by software without hardware. Therefore, a user directly downloads a simulated file in a radio terminal and can use it. Also, the user can possess the simulated file without verifying it.

Fourth, the present invention improves a performance for a common use and a re-use of software.

Finally, since work can be carried out in accordance with its function by a modulated structure, an external developer can easily perform development work without any source code. This can remove a problem related to security.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A Basic Architecture for Software Environment (BASE) of a radio terminal comprising:
a task part having a plurality of tasks and generating working events;
a BASE user interface (UI) independently performing an application program by module by using the events generated by the task part; and
an application program interface (API) interfacing the application program with a program development kit (PDK) library so that the application program may access the PDK library.

2. The BASE as claimed in claim 1, wherein the BASE UI includes;
a PDK handler handling events generated within the PDK and signals and the events generated by the task part;
a preprocessor processing and determining events to be first processed among the events output from the PDK handler;
a SPY handler processing and determining events to be processed in common for all of the application programs among the events not processed by the preprocessor;
a state machine processing the events output from and not processed by the SPY handler, wherein the events are not independently processed;
an application part independently processing the events output from and not processed by the SPY handler;
an application handler providing and identifying the corresponding event for each application of the application part; and
an application manager part managing, activating, and terminating the application part.

3. The BASE as claimed in claim 1, the tasks are HandSet(HS) task, Main Control(MC) task, Call Manager(CM) task, and File System(FS) task.

4. The BASE as claimed in claim 1, the SPY handler includes;
a system spy checking whether events processed in common exist or not; and
an application SPY processing corresponding events after operation of the system spy.

5. A method of handling events in a BASE of a radio terminal, the BASE including an application handler, a plurality of applications, and a PDK of development environment, the method comprising:
(a) transforming all of the events except for events used by a PDK under the status of development provided by the BASE among the generated events into available events and storing the transformed events in a queue;
(b) orderly reading first stored events from the queue and preprocessing predetermined events;
(c) processing events required in common by all of the application programs among the events not processed in the step (b);
(d) processing events such as startup, end, call, and idle among the events not processed in the step (c) and searching an activated application;
(e) transferring the events not processed in the step (d) to the searched application;
(f) processing the events not processed using an independent program module of the activated application.

6. The method as claimed in claim 5, wherein the events transformed in the step (a) include key down, timer check, Short Message Service(SMS), serial, and pointing.

7. The method as claimed in claim 5, wherein the step (f) includes;
(a1) selecting one of a plurality of applications and initiating variables;
(b1) informing an application handler of the selected application;
(c1) generating a terminating event for terminating an activated application at the application handler and providing the activated application with it;
(d1) performing the terminating procedure after processing all of the remaining events stored in the queue when the activated application receives the terminating event;
(e1) generating an activating event for the selected application at the application handler and transferring it to the selected application;
(f1) transferring the selected application's information to the application handler and storing the transferred information at the application handler; and
(g1) performing an initiating procedure and processing input events at the selected application.

8. The method as claimed in claim 7, wherein the information stored by the application handler includes file header information, registery information, location information of a program code, location information of small icon data, location information of large icon data, location information of resource data, a code table of program offset, icon data of a program code, and resource data.

9. The method as claimed in claim 7, wherein the terminating procedure of a current application activated from the selected application includes;
(a2) transferring a terminating signal for terminating the current application into the application handler;
(b2) generating a terminating event informing that the current application terminates when the application handler receives the terminating signal and generating an activating event informing that a previously terminated application is again activated;
(c2) processing all of the events remaining in the queue at the current application and transferring the generated terminating event to a current application through the application handler to perform the termination procedure;
(d2) transferring the generated activating event to the previously terminated application through the application handler;
(e2) reading information of the previously terminated application and replacing a run function with a PXP file of the previously terminated application at the application handler, so that all of the events to be later generated are transferred to an application again activated from the previously terminated application; and
(f2) initiating the activated application again, processing the input activating event, and terminating the current application.

10. The method as claimed in claim 5, wherein the preprocessed events in the step (b) are either for displaying the status or for animation.

11. The method as claimed in claim 5, wherein the events required in common by all of the application programs in the step (c) are those having the SPY.

12. The method as claimed in claim 5, wherein the application of the independent program module is as follows.

| State of Conventional | |
|---|---|
| Qualcomm's code | Independent application |
| UI_CODE_S | LOCK API |
| UI_MESSAGE_S | DISPLAY API |
| UI_INFO_S | DISPLAY API |
| UI_LIST_S | PDK API |
| UI_NUMEDIT_S | PDK API (IDLE, CALL) |
| UI_RCL_S | CALL HISTORY APP |
| UI_STO_S | PIM APP |
| UI_MENU_S | SETTING APP |
| UI_SMS_S | (FOREGROUND) SMS APP |
| | (BACKGROUND) SPY |
| UI_ALPHAEDIT_S | EDIT API |
| UI_SERVICE_S | SETTING APP |
| UI_CLI_S | CLI API |
| UI_HELP_S | PDK API |
